(19) United States
(12) Patent Application Publication
(10) Pub. No.: US 2007/0229844 A1
(43) Pub. Date: Oct. 4, 2007

(54) Method of and apparatus for measuring layer thicknesses and layer homogeneities in containers

(76) Inventors: Lothar Holz, Berlin (DE); Markus Lankers, Berlin (DE); Georg Roessling, Berlin (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/582,858

(22) Filed: Oct. 17, 2006

(30) Foreign Application Priority Data
Oct. 21, 2005 (DE) 10 2005 050 432.9

(51) Int. Cl. G01B 11/02

(52) U.S. Cl. 356/503

(57) ABSTRACT

The invention concerns a method of measuring layer thicknesses and layer homogeneities in transparent, internally lubricant- and water-repulsion-coated containers, wherein a lens (2) focuses polychromatic light on to the internal coating (1B) of the container (1), the reflected light is detected again, coupled into a spectrometer and registered by way of a sensitive multichannel detector (7), and corresponding signals are transferred to an electronic evaluation means (8) which digitises the signals and computes the layer thickness from the interference pattern.

### CROSS REFERENCE TO RELATED APPLICATION

This application claims priority under 35 USC §119 to German application Ser. No. 10 2005 050 432.9 filed 21 Oct. 2005.

### BACKGROUND OF THE INVENTION

1. Technical Field

The invention pertains to the field of containers, and in particular to pharmaceutical vessels.

2. Discussion of related art

For optimisation and correct dosage metering of lubricant and water-repulsion agents such as for example silicone oils and silicone oil emulsions, the homogeneity and layer thickness of the lubricant film must be capable of being non-destructively measured in the unopened container.

Silicone oil and silicone oil emulsions are used as lubricant or water-repulsion agents in pharmaceutical production for coating flasks and syringes. It is known that the resulting lubricant layers can be investigated and characterised in laboratory technology conditions by means of force/travel diagrams (Tobias Mundry, Dissertation HU-Berlin ‘Einbrennsilikonisierung bei pharmazeutischen Glaspackmitteln’—Analytical studies of a production process), extraction and spectroscopic determination of the lubricant (Spanjers L G C & de Kleijn J P: ‘The Determination of Traces of Silicon Oil in Pharmaceutical Preparations By Atomic Absorption Spectroscopy’ Pharm Weekbl Sci Ed 7(6): 291 [1985]), contact angle measurements (Spitze, L A & Richards, D O: ‘Surface Studies on Glass Part 1. Contact Angles’ J Appl Phys 18: 904-11 [1947]) or by IR-microscopic means (Gardella J A Jr, Grobe G L, Hopson W L & Eyring E M: ‘Comparison of Attenuated Total Reflectance and Photoacoustic Sampling for Surface Analysis of Polymer Mixtures by Fourier Transform Infrared Spectroscopy’ Anal Chem 56: 1169-1977, [1984]). In those investigations however the containers have to be emptied and destroyed. The samples are no longer available for subsequent further investigations. In addition 100% production control is not possible with those destructive testing methods.

It is also known that light reflected at thin layers of different refractive indices has an interference pattern which makes it possible to calculate a refractive index or the layer thickness. That procedure is used for characterising coatings in the field of optics or for the production of interference filters (Warren J Smith, Modern Optical Engineering).

The object of the invention is to provide a simple method and an associated apparatus for contact-less and destruction-free measurement of the thickness of lubricant and water-repulsion films in filled and unfilled transparent containers, in particular pharmaceutical vessels, by means of interference reflectometry. The invention also seeks to provide that it is possible to determine homogeneity of the coating.

### DISCLOSURE OF INVENTION

Accordingly, the invention provides a method of measuring layer thicknesses and layer homogeneities in transparent, internally lubricant- and water-repulsion-coated containers, characterised in that a lens focuses polychromatic light on to the internal coating of the container, the reflected light is detected again, coupled into a spectrometer and registered by way of a sensitive multichannel detector, and corresponding signals are transferred to an electronic evaluation means which digitises the signals and computes the layer thickness from the interference pattern.

The invention also provides associated equipment.

Thin layers can ideally be characterised by means of interference methods. For that purpose a focussed light beam of preferably polychromatic light is focussed on to the layer to be measured in the corresponding vessel. The reflected light is coupled into a spectrometer and detected with a sensitive multichannel detector. The resulting signal is transferred to a computer for determining the layer thickness and the layer thickness is computed. Computation of the layer thickness is effected for example in accordance with the following formula:

$$2 * D * {n}_{D} = \frac{{λ}_{max 1} * {λ}_{max 2}}{{λ}_{max 1} - {λ}_{max 2}}$$

wherein D=the layer thickness, n_{D}=the refractive index of the interface, λₘₐₓ₁=an interference maximum1 and λₘₐₓ₂=an interference maximum2 for adjacent interference maxima.

Information about the homogeneity of the layer can be achieved by way of the imaging of the reflected light on to an imaging camera, for example a CCD camera. Images which do not involve any change in the color shade show a very homogeneous layer, while strong color changes point to severe non-homogeneities in the lubricant layer. A very thin layer (d˜50 nm) darkens the image. A large layer thickness (D>1 μm) causes the image to appear gray. In the intermediate range of layer thicknesses, all spectral colors are prevalent.

A major advantage of this is the possibility of determining the layer thickness in filled and unfilled vessels without having to destroy them so that it is possible to monitor production processes and end products.

It is also advantageous if the light is focussed on to the region which in filled vessels is usually filled with an air bubble in order to obtain a stronger reflection signal in regard to the layer to be measured.

Averaging of the layer thickness is possible by rotation of the vessel.

It is further proven to be advantageous to combine the layer thickness determining operation with a movement of the object being measured and thus to permit inline checking of the silicone layer.

### BRIEF DESCRIPTION OF THE DRAWINGS

The invention is described in greater detail hereinafter by means of embodiments by way of example with reference to the drawings. Identical components or components which have the same effect are denoted by the same references.

In the drawings:

FIG. 1 is a diagrammatic view of the apparatus for determining layer thickness in accordance with a first embodiment,

FIG. 2 shows the result of a layer thickness determining operation in accordance with the first embodiment,

FIG. 3 shows a diagrammatic view of the apparatus for determining homogeneity in accordance with a first embodiment,

FIG. 4 is a diagrammatic view of the apparatus for determining layer thickness in accordance with a second embodiment, and

FIG. 5 shows a diagrammatic view of the apparatus for determining homogeneity in accordance with a second embodiment.

### DETAILED DESCRIPTION

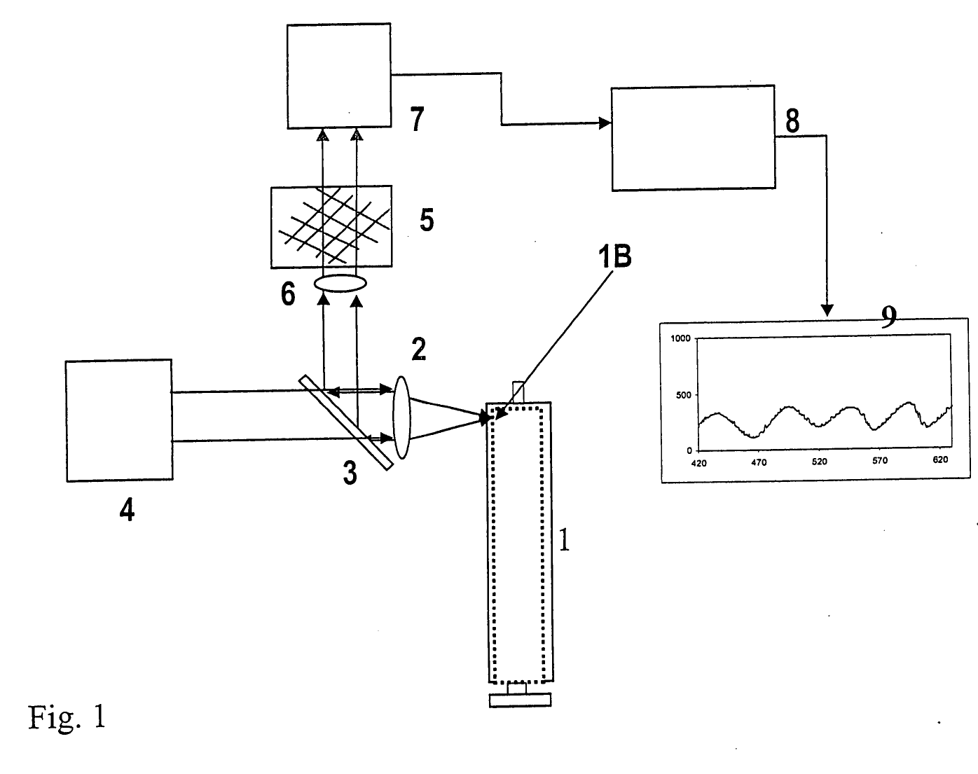

Referring to FIG. 1 the beam from a polychromatic light source 4 is focussed by way of a semi-transparent deflection mirror 3 and a lens 2 through the transparent wall of the vessel 1 on to the inward side of the wall which carries the silicone film 1B. The reflected light issues through the semi-transparent mirror 3 and is coupled by a lens 6 into a spectrometer 5 and detected with a sensitive multichannel detector 7. The resulting signal of intensity in relation to wavelength is transferred to a computer 8 for determining the layer thickness, the layer thickness is computed and outputted at 9. Computation of the layer thickness is effected for example in accordance with the following formula:

$$2 * D * {n}_{D} = \frac{{λ}_{max 1} * {λ}_{max 2}}{{λ}_{max 1} - {λ}_{max 2}}$$

wherein D=the layer thickness, n_{D}=the refractive index of the interface, λₘₐₓ₁=an interference maximum1 and λₘₐₓ₂=an interference maximum2 for adjacent interference maxima.

The usable wavelength range is dependent on the material and in the case of glass for example is 300 nm-2.5 μm. That results in a layer thickness measurement range of 100 nm-50 μm in accordance with the formula:

$$2 * D * {n}_{D} = \frac{{λ}_{max 1} * {λ}_{max 2}}{{λ}_{max 1} - {λ}_{max 2}}$$

The measurement range can be enlarged by the use of fit routines employing the dispersion of the refractive index of the silicone layers towards smaller layer thicknesses.

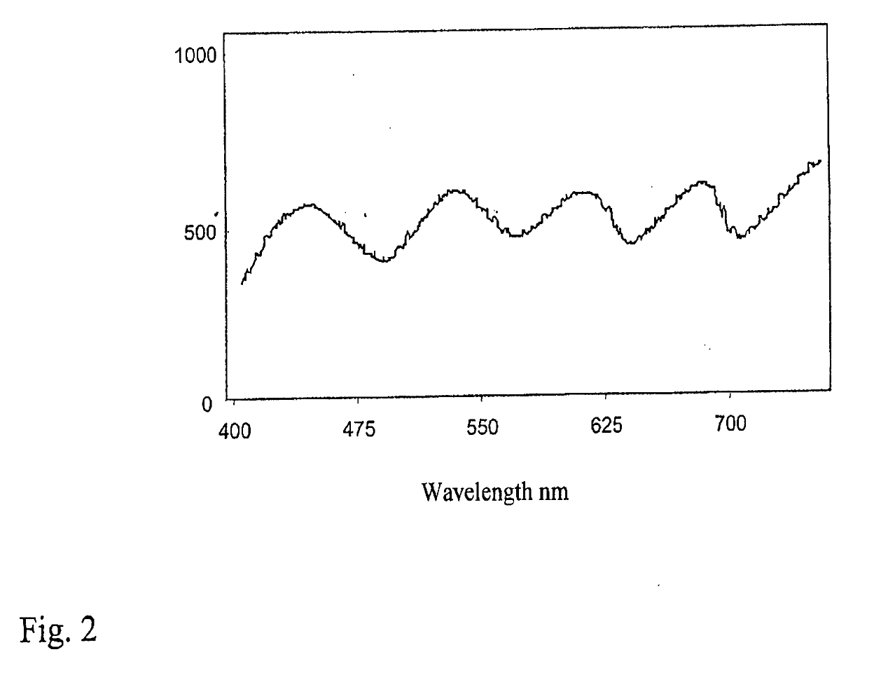

FIG. 2 shows the interference pattern which was obtained in accordance with the above-described method with the apparatus of the first embodiment by irradiating the internal surface of a medical syringe with polychromatic light. A spectrometer 5 with a focal length of 150 mm and a CCD detector 7 were used for the detection operation. The light was registered in the range of 420-700 nm. The layer thickness ascertained is 1.1 μm.

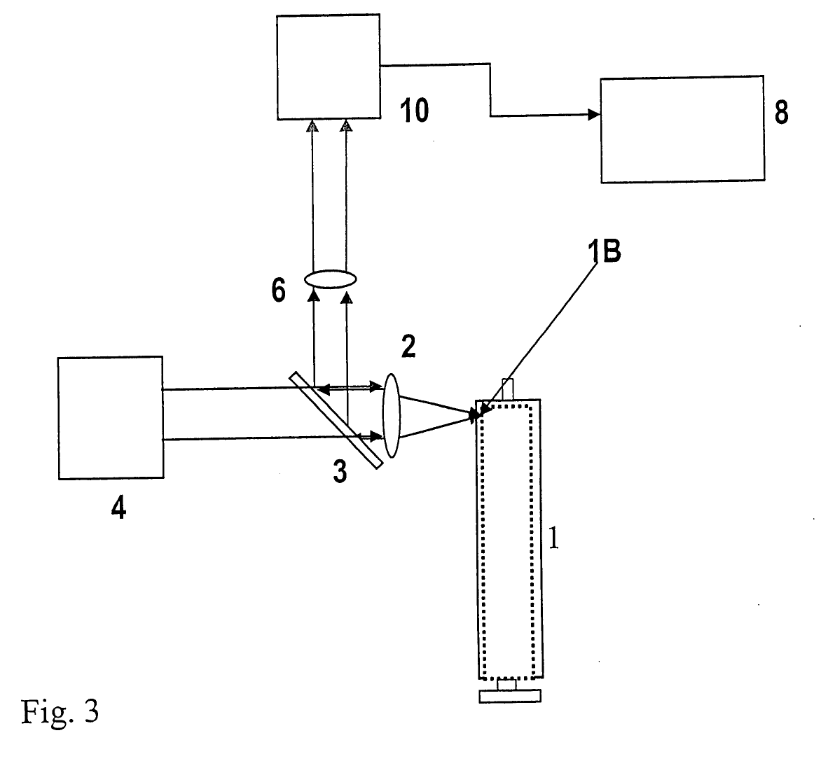

An embodiment for determining homogeneity can be seen from FIG. 3.

The beam from a light source 4 is focussed by way of a semi-transparent deflection mirror 3 and a lens 2 through the transparent wall of the vessel 1 on to the inward side of the wall which carries the silicone film 1B. The image of the reflected light is formed on a video camera 10 by way of the semi-transparent mirror 3 and a lens 6. The resulting signal is transmitted to a computer 8 for storage and display of the signal and homogeneity is assessed. The measurement range of white light interference is in the range of a low interference order: between about 50 nm and 1 μm. Measurement of the layer thickness is effected on the basis of association of the measured signal in the color space by means of the computer 8.

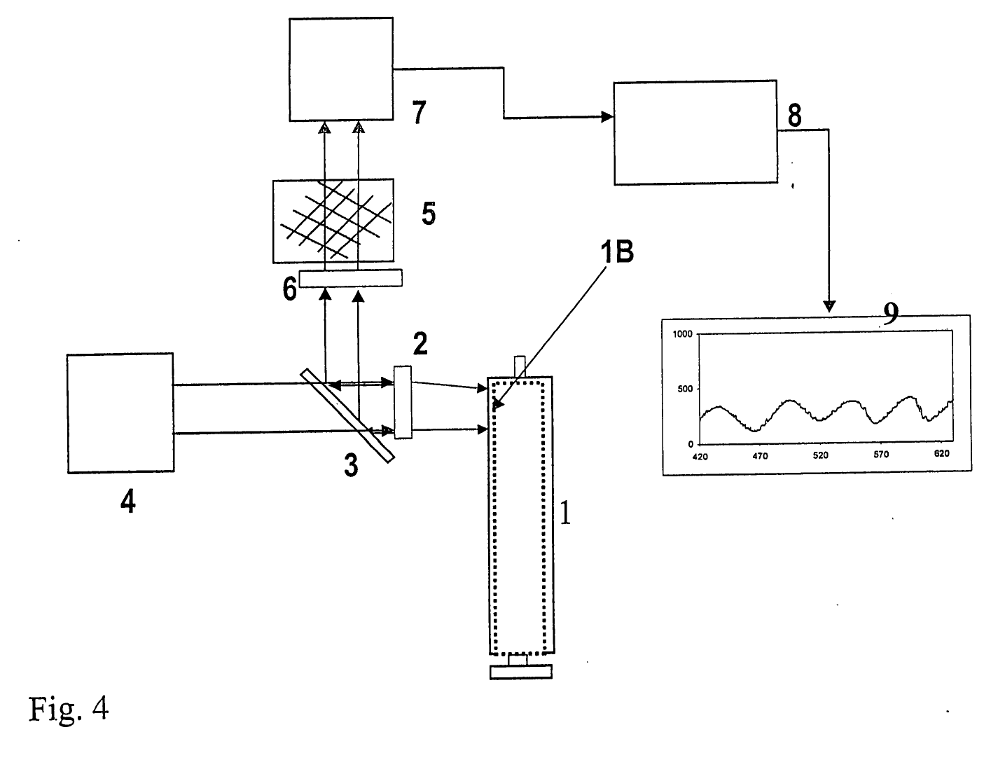

A second embodiment for determining layer thickness can be seen from FIG. 4.

The beam from a polychromatic light source 4 is focussed by way of a semi-transparent deflection mirror 3 and a cylindrical lens 2 through the transparent wall of the vessel 1 on to the inward side of the wall of a cylindrical vessel, for example a medical syringe, which carries the silicone film 1B. The reflected light is focussed by way of a cylindrical lens 6 on to the slit of an imaging polychromator 5 in such a way that the focal line of the cylindrical lens 6 extends precisely on the slit. In the polychromator 5 the light is spread in respect of wavelength and registered with a multichannel detector 7 in such a way that one direction of the detector corresponds to the wavelength spreading and the other direction of the surface detector corresponds to position resolution which was already implemented along the slit. The signal is digitised and passed to a computer 8 for display 9 of the positionally resolved layer thickness and further signal processing.

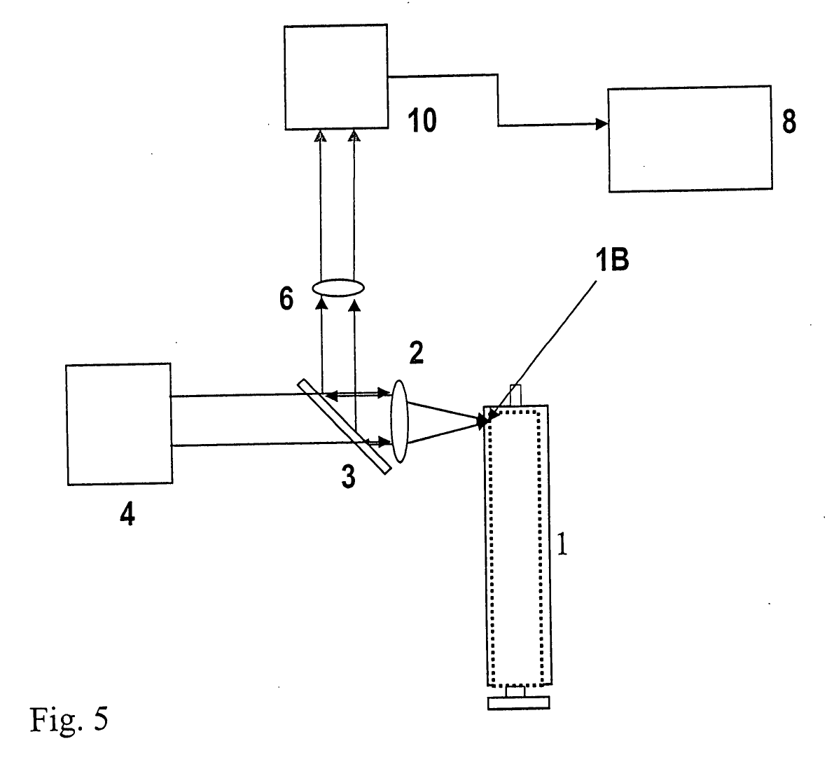

In a second embodiment for determining homogeneity, which is shown in FIG. 5, quasi-monochromatic light is focussed with a spherical lens 2 on to the inward side of the vessel 1. The reflected light is deflected by a mirror 3 and projected by way of a lens 6 on to a two-dimensional image detector 10, for example a video camera. The signal is digitised and passed to a computer 8 for display and further signal processing.

In that case the measurement range can be established not in dependence on wavelength but by way of the interference pattern: lines of equal thickness are displayed. The following applies for the thickness of the dark regions: D=m*lambda/2, wherein m is the interference order and lambda is the wavelength in silicone.

It is possible to assess the uniformity of the layer.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method of measuring layer thicknesses and layer homogeneities in transparent, internally lubricant- and water-repulsion-coated containers, characterised in that a lens (2) focuses polychromatic light on to the internal coating (1B) of the container (1), the reflected light is detected again, coupled into a spectrometer (5) and registered by way of a sensitive multichannel detector (7), and corresponding signals are transferred to an electronic evaluation means (8) which digitises the signals and computes the layer thickness from the interference pattern.

2. A method as set forth in claim 1 characterised in that the light is focussed on to the internal coating (1B) with a cylindrical lens (2) and the reflected light is focussed on to the slit of a polychromator (5).

3. A method as set forth in claim 1 characterised in that the reflected light is imaged on to a video camera (11) and the resulting image is used for assessment of homogeneity.

4. A method as set forth in claim 1 characterised in that quasi-monochromatic light is focussed on to the internal coating (1B) of the container (1) and the reflected light is imaged on to a video camera (11), the resulting image being used for assessing homogeneity.

5. A method as set forth in claim 1 characterised in that the light is focussed on to the inward side of a region, filled with air, of the vessel to be measured.

6. A method as set forth in claim 1 characterised in that the light is in the wavelength range of between 200 and 1100 nm.

7. A method as set forth in claim 1 characterised in that the coated vessels are moved past the lens (2).

8. A method as set forth in claim 1 characterised in that the container is set in rotation.

9. Apparatus for measuring layer thicknesses and layer homogeneities in transparent, internally lubricant- and water-repulsion-coated containers, characterised by a lens (3) for focussing polychromatic light on to the internal coating (1B) of the container (1), a mirror (2) for detecting the reflected light again, a lens (6) for coupling the light into a spectrometer (5), a sensitive multichannel detector (7) for registering signals received from the spectrometer (5) and transferring them to an electronic evaluation means for digitisation and computation of the layer thickness from the reference pattern.

10. Apparatus as set forth in claim 9 characterised by a video camera (10) for imaging the reflected light, the resulting image being used for assessing homogeneity.

11. Apparatus as set forth in claim 9 characterised in that the lens (2) for focussing the light on to the internal coating (1B) of the container (1) is a cylindrical lens and the spectrometer is a polychromator, on to the gap of which the reflected light is focussed.

12. Apparatus as set forth in claim 9 characterised by a conveyor belt for moving the coated containers past the lens (2).

13. Apparatus as set forth in claim 9 characterised by a device for rotating the containers.
